(19) United States
(12) Patent Application Publication
(10) Pub. No.: US 2022/0108413 A1
(43) Pub. Date: Apr. 7, 2022

(54) Systems and Methods for Providing Civil Discourse as a Service

(71) Applicant: Convertsation Ed Inc., Suffern, NY (US)

(72) Inventors: Daniel Hack, Pittsburgh, PA (US); Jeremy Brown, Philadelphia, PA (US); Matthew Henderson, Pittsburgh, PA (US); Michael Lepori, Cambridge, MA (US); Logan Snow, Pittsburgh, PA (US)

(73) Assignee: Convertsation Ed Inc., Suffern, NY (US)

(21) Appl. No.: 17/495,726

(22) Filed: Oct. 6, 2021

Related U.S. Application Data
(60) Provisional application No. 63/088,110, filed on Oct. 6, 2020.

(51) Int. Cl. G06Q 50/20; G09B 5/06; H04L 12/18

(52) U.S. Cl. CPC G06Q 50/20; H04L 12/1822; G09B 5/06

(57) ABSTRACT

Systems, methods and apparatuses are provided that facilitate structured and semi-structured discussion environments for educational and commercial uses. The embodiments may allow students to participate in live, text-based chat groups to discuss any topic. Moreover, the embodiments may include analytical features to allow educators and administrators to track a wide variety of metrics relating to student behaviors, progress and/or discourse.

### CROSS-REFERENCE TO RELATED APPLICATIONS

The present application claims the benefit of U.S. Provisional Patent Application 63/088,110, titled “Systems and Methods for Providing Civil Discourse as a Service,” filed Oct. 6, 2020, which is incorporated by reference herein in its entirety.

### BACKGROUND

The migration of education and much of our civic discourse online has presented significant challenges to educators, parents and young people. That online discourse has become divisive and too often devolves into name-calling and shouting matches. Furthermore, the spreading of dubious news sources has eroded our “town square” and harmed young peoples' ability to learn, discuss and participate. While social platforms have taken small steps to improve, young people who increasingly debate and form their opinions on social platforms have little guidance, skill building opportunities or modeling to develop healthy conversation skills or to listen to alternative perspectives.

As both K-12 education and colleges accelerate their use of online classrooms, skills that allow healthy, open-minded discourse are increasingly critical to education. Peer-to-peer interaction is a key element to education; sharing one's opinion and hearing others' thoughts via conversation is one of the most powerful methods of learning and growing. But online offerings struggle to provide synchronous engagement and small group, real-time interactivity to students.

Currently, online classroom interactivity is overly dependent on video, like the ZOOM application, which requires robust broadband access and is largely used in an asynchronous, one-way manner. These platforms rarely integrate into learning management systems (“LMSs”), and provide little engagement or topic knowledge metrics to educators. When education was forced online during the coronavirus pandemic, most teachers simply tried to shoehorn their usual teaching onto video platforms like ZOOM, which are not built for the classroom. Dissatisfaction was widespread among teachers, students and parents about poor online engagement, and challenges with video formats were significant in spring of 2020, motivating many schools to look for new solutions. Furthermore, platforms like, MISMATCH have few objectives besides promoting discourse generally. Additionally, MISMATCH focuses on face-to-face conversations.

Furthermore, conversations conducted outside of the classroom setting generally occur in unstructured settings like GOOGLE DOCS, GROUPS, CANVAS, and/or BLACKBOARD, where conversations are rarely live or measured, and comments are asynchronous, paragraph by paragraph, over a long period of time. Many online instructors and students admit that when class video comments are required, a vast majority of the comments are posted at the end of the semester or course, and such comments offer little interactivity with classmates or instructors. The use of such asynchronous means of conversation results in students copying each other, neglecting to read long paragraphs, and practicing a form of discourse that is ineffective, hard to digest, and non-transferable to other real-life situations (e.g., social media).

In a similar vein, the KIALOED platform, which attempts to improve discourse through a web of conversations that provide perspectives from both sides of various issues and topics, is largely focused on asynchronous dialogue. Furthermore, currently available platforms fail to focus on depolarization of online conversations. In fact, a survey among educators displayed a strong preference for the platform described in the embodiments over other currently available platforms, such as MISMATCH.

Accordingly, there is a need for online platforms that actively promote healthy, informed, civil discourse on a wide variety of topics between users in real-time from all around the world. It would be further helpful if such platforms could monitor activity on the platform and gather analytics regarding user behavior on its platforms over time.

### SUMMARY

In accordance with the foregoing objectives and others, exemplary methods and systems are disclosed herein to facilitate and promote healthy online discourse. The disclosed systems and methods offer an entertaining way for students to build skills and experience discussing important subjects in a structured, healthy way, by means of live group discussions. Such skills and experience are transferrable to the open frontiers of social media and to real-world, face-to-face conversations. The disclosed embodiments are also adapted to allow instructors to create assignments for their students to be completed remotely. As part of the assignments, students are required to hold virtual conversations amongst their own classmates or with another classroom that they have connected with.

To further facilitate healthy discourse, the present invention utilizes a matchmaking feature which enables participation between multiple classrooms, from classrooms within one educational institution, to classrooms across the globe, assuring that students engage with perspectives different from their own. The all-in-one platform further allows students to participate in live, text-based chat groups to discuss any topic. The live, text-based chat format utilized by the described embodiments mimic the actions people most regularly take online when discussing contentious issues, such as messaging and commenting, rather than video chatting.

The described embodiments further include powerful analytical features allowing for the system and certain users (e.g., the educators) to track a wide variety of metrics on user behavior (e.g., level of toxicity) and the quality and level of progress of discourse taking place on the platform.

In one embodiment, a computer-implemented method for facilitating online discourse is provided. The method may include receiving class information associated with a class from a user. The class information may include a class name and a class description. The method may also include storing the class. The method may also include receiving assignment information associated with an assignment from the user. The assignment information may include a requirement to participate in a virtual conversation. The virtual conversation may include a topic. The method may also include storing the assignment. The method may further include receiving, from the user, a request to create a first virtual conversation room and a second virtual conversation room. The first virtual conversation room and the second virtual conversation room may be associated with the virtual conversation. The method may also include receiving, from the user, a request to place a second user in the first virtual conversation room, a request to place a third user in the first virtual conversation room, a request to place a fourth user in the second virtual conversation room, and a request to place a fifth user in the second virtual conversation room. The method may include displaying the class to the second user. The method may also include receiving a request from the second user to join the first virtual conversation room. The method may further include approving the request from the second user. The method may include displaying the first virtual conversation room to the second user.

In another embodiment, a system is provided that includes one or more computers and one or more storage devices storing instructions that when executed by the one or more computers cause the one or more computers to perform operations for facilitating online discourse. The operations performed may include receiving class information associated with a class from a user. The class information may include a class name and a class description. The operations performed may also include storing the class. The operations performed may further include receiving assignment information associated with an assignment from the user. The assignment information may include a requirement to participate in a virtual conversation. The virtual conversation may include a topic. The operations performed may also include storing the assignment. The operations performed may further include receiving, from the user, a request to create a first virtual conversation room and a second virtual conversation room. The first virtual conversation room and the second virtual conversation room may be associated with the virtual conversation. The operations performed may also include receiving, from the user, a request to place a second user in the first virtual conversation room, a request to place a third user in the first virtual conversation room, a request to place a fourth user in the second virtual conversation room, and a request to place a fifth user in the second virtual conversation room. The operations performed may include displaying the class to the second user. The operations performed may also include receiving a request from the second user to join the first virtual conversation room. The operations performed may further include approving the request from the second user. The operations performed may include displaying the first virtual conversation room to the second user.

### BRIEF DESCRIPTION OF THE DRAWINGS

FIG. 1 shows an exemplary user interface screen 100 displaying a profile creation page.

FIG. 2 shows an exemplary user interface screen 200 displaying a pre-conversation waiting room.

FIGS. 3, 4A and 4B show exemplary user interface screens 300, 400 displaying a virtual conversation room.

FIGS. 5A-5B show exemplary user interface screens 500, 502 displaying a resource board share screen and resource board search screen, respectively.

FIG. 6 shows an exemplary user interface screen 600 displaying time remaining in a virtual conversation.

FIGS. 7A-7B show an exemplary landing page screen 700.

FIG. 8 shows an exemplary assignments screen 800.

FIG. 9 shows an exemplary conversation room groups screen 900 for created assignments.

FIGS. 10A-10D show an exemplary conversation reports screen 1000.

FIG. 11 shows a block diagram of an exemplary online discourse system 1100 according to an embodiment.

FIG. 12 shows a block diagram illustrating a computing machine 1200 and modules in accordance with one or more embodiments presented herein.

### DETAILED DESCRIPTION

Various systems, methods, and apparatuses are disclosed herein to provide structured virtual conversation systems and methods for educational and other purposes. References herein to “conversation platform,” “discourse platform,” “the described embodiments,” or the “the disclosed embodiments” should be understood to refer to some but not necessarily all of the various features and versions of the described embodiments, which are not limited to one embodiment or invention, but rather encompass many embodiments and inventions which are described herein. Furthermore, references herein to “conversation” and “discourse” refer to the virtual conversation and discourse that take place in virtual conversation rooms.

The described embodiments generally allow for impactful changes in online discourse by fostering healthier discussions about difficult subjects. Specifically, the described embodiments attempt to teach students how to communicate online in a productive and healthy manner. As such, the disclosed embodiments connect students and educators, whether in the same class or across different classrooms around the world, together in a virtual conversation room, and provide the students and educators with tools to have productive, healthy, open-minded discussions. Such virtual conversation room tools may include, but are not limited to: an algorithmic character count for balanced participation among conversation members, time-limited discussions, and post-conversation reports. With such features, educators are both able to monitor and jump into conversations in real-time, as well as offer live feedback to students. Furthermore, students are able to share curated resources such as news articles, images, and videos with others in their conversation rooms. The virtual conversation room also includes features such as artificial intelligence (“AI”)-powered suggested phrases which suggests open-minded sentence fragments for users to use in their messages, a resource board for evidence-based claims and research, and a drawing board for students to draw out their ideas.

The disclosed embodiments further include analytical features adapted to provide educators with granular levels of information about each student's profile of interaction during and after a scheduled virtual conversation. These analytical features allow for targeted interventions aimed at meeting each individual student's needs. For example, when a conversation is over, an educator may be provided with a conversation report communicating how each student performed in the discussion. This report is powered by AI integrations that provide teachers with how toxic the students were, a user's sentiment (positive/negative), how many new ideas each student brought up, how relevant their comments were, and much more. The educators may then provide feedback based on the conversation reports to the students.

The disclosed embodiments also allow educators to more easily structure conversations for their students around subjects they are already teaching in class. Such embodiments allow educators to create assignments, share topic prompts and resources (e.g., news articles, images, and videos) and tailor discussions to their learning objectives. The platform also allows students to easily join classes that educators have created, via one-time class codes provided by the educators. The described embodiments further allow for ease of remote learning and completion of assignments by students. The described embodiments allow for students to complete their assignments anytime throughout the week in a variety of locations, whereas currently available systems are restricted to utilization in the classroom setting.

As described below, the platform may be applied in a wide variety of settings (e.g., educational). It will be appreciated that a broad range of users, including administrative users (e.g., educators in an educational setting) and regular users (e.g., those with no administrative privileges, or students in an educational setting), may utilize the embodiments described herein. For convenience and ease of understanding, the embodiments below will be described in the context of an educational setting. Additionally, for convenience, administrative users are collectively referred to as “educators,” and users with no administrative privileges are collectively referred to as “students,” and both administrative and non-administrative users are collectively referred to as “users.”

The described embodiments can also be used in settings other than educational settings. For example, a complete discourse platform may be provided. The described embodiments may also be integrated with platforms such as GOOGLE CLASSROOM, BLACKBOARD, POWERSCHOOL, or other similar assigning/grading software. An instructor may submit a grade in the invention and have it sync to the LMS. Furthermore, the described embodiments may have Single Sign On (SSO) available so that student accounts are attached to their school federated identity.

The described embodiments may allow a user to sign up for the discourse platform by creating a new account. The user may first input account information, including: first name, last name, birthdate, gender, whether the user is a student or a teacher, email, and password. The sign-up screen may then require the user to confirm the newly created password and submit the information. Upon submission, the user's account is created.

Upon submission of the account information, the user's account is created. The user may then access the discourse platform by signing into the system via a sign-in page. To sign in, the user will be required to provide an email and a password, then submit the information. If the user forgets the password, they may select a link to reset the password and provide their email address. The system then sends a link to the user to reset the password.

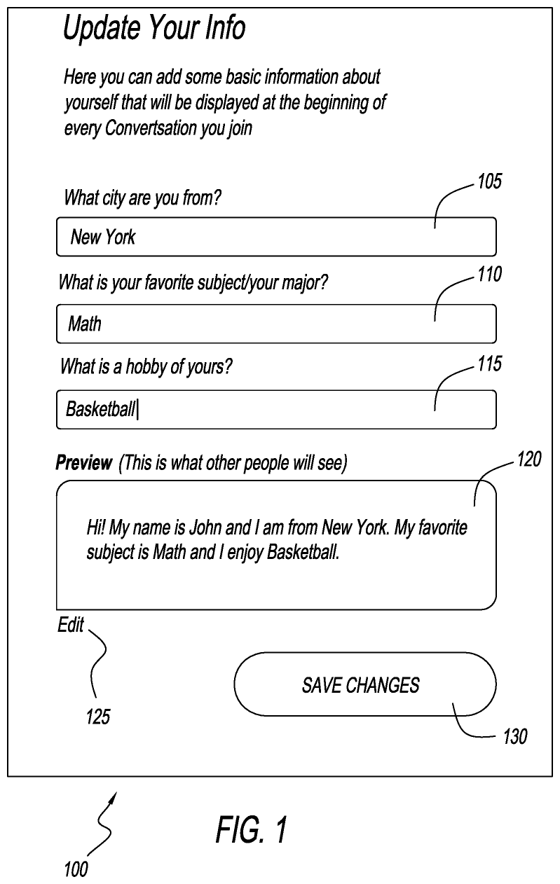

Referring to FIG. 1, a user interface screen 100 for creating a profile is provided. As shown, the system may require the user to create a publicly accessible profile by requiring the user to input the city they are from 105, their favorite subject or their major 110, and a hobby of theirs 115. In the embodiments shown, the user may provide the information to the system by submitting the answers via freeform text boxes. The system may further allow the user to preview what their profile will look like to other users. For example, if a user provides their name as John, their favorite subject as “Math,” and a hobby as “Basketball,” the system may display a preview 120 at the bottom of the profile creation screen before the submission button with the following: “Hi! My name is John and I am from New York. My favorite subject is Math and I enjoy Basketball.” The system may also allow the user to edit the preview 125. Once the user inputs the information and reviews the preview, the user may click a link 130 to save the changes.

Once the user creates their profile, he may schedule or be scheduled to join virtual conversation rooms via a scheduling portal provided by the platform. The scheduling portal allows users to input their availabilities for the extent of a virtual conversation assignment. The system may analyze the availability submitted by all users that are required to complete the assignment, then assign each user to a virtual conversation room of between two to five people who are available at the same time, regardless of time zone. All users in the same group will be in the same virtual conversation room for at least a part of the duration of the assignment. In other embodiments, the groups for the virtual conversation rooms may be manually created by an educator.

In certain embodiments, the scheduling may be done via a scheduling extension application available for various systems (e.g., Google Android, Apple iOS, etc.). In such embodiments, educators may input their course schedules and upload calendars to a directory marked by their respective schools. Students will then be able to find their course schedules and sync the course schedules with their alarms and calendars to stay up-to-date on their courses while learning from home. The application may further integrate with email platforms to provide alerts and links to both the ZOOM application and a virtual conversation room, if either are utilized.

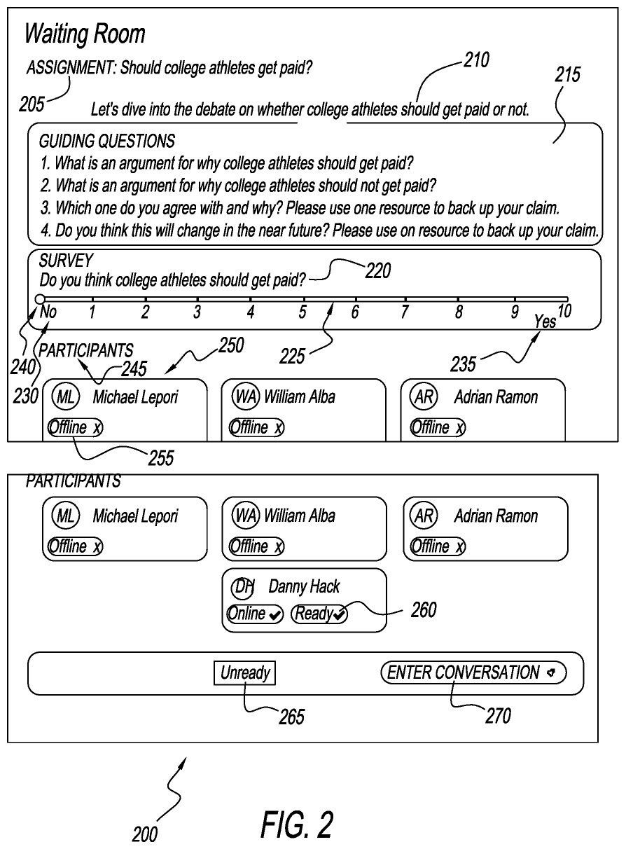

Referring to FIG. 2, a user interface screen 200 displaying a pre-conversation waiting room is provided. Before entering a virtual conversation room, the user may be directed to the pre-conversation waiting room screen 200. As shown, the pre-conversation waiting room screen may display a conversation assignment topic 205 (e.g., “ASSIGNMENT: Should college athletes get paid?”), a conversation description 210 (“Let's dive into the debate on whether college athletes should get paid or not”), and/or one or more prompt(s)/guiding questions 215 (e.g., “What is an argument for why college athletes should get paid?”).

The pre-conversation waiting room screen may further include one or more survey questions 220 (e.g., “Do you think college athletes should get paid?”). In the embodiment shown, the survey question may be accompanied by a sliding scale 225 with one end being “No/0” 230 and the other end being “Yes/10” 235 and may allow the user to drag a slider 240 somewhere along the sliding scale to input their response. In the embodiment shown, for example, the slider 240 is situated at the “No/0” position. The pre-conversation waiting room screen may also include a “Participants” section 245 displaying one or names of the group members of the virtual conversation room (e.g., “Michael Lepori” 250). As shown, each displayed group member name may be accompanied by an icon indicating whether they are online (e.g., “online,” “offline” 255) and an icon indicating their readiness status (e.g., “ready” 260, or “unready”).

The screen may further include a link 265 allowing the user to set their own status (e.g., “Unready”) and a link 270 allowing the user to enter the virtual conversation room (e.g., “Enter Conversation”).

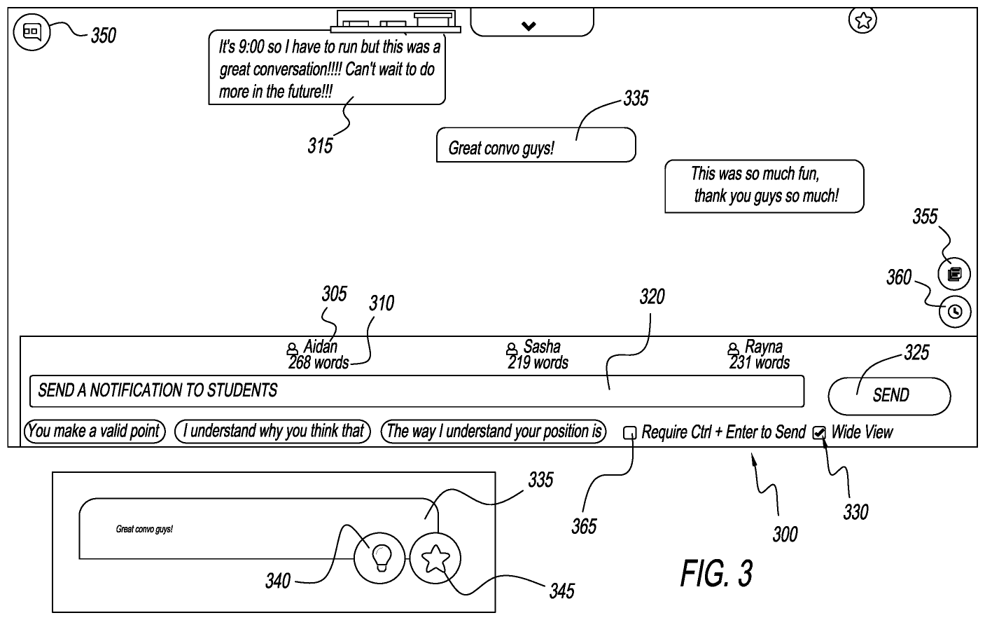

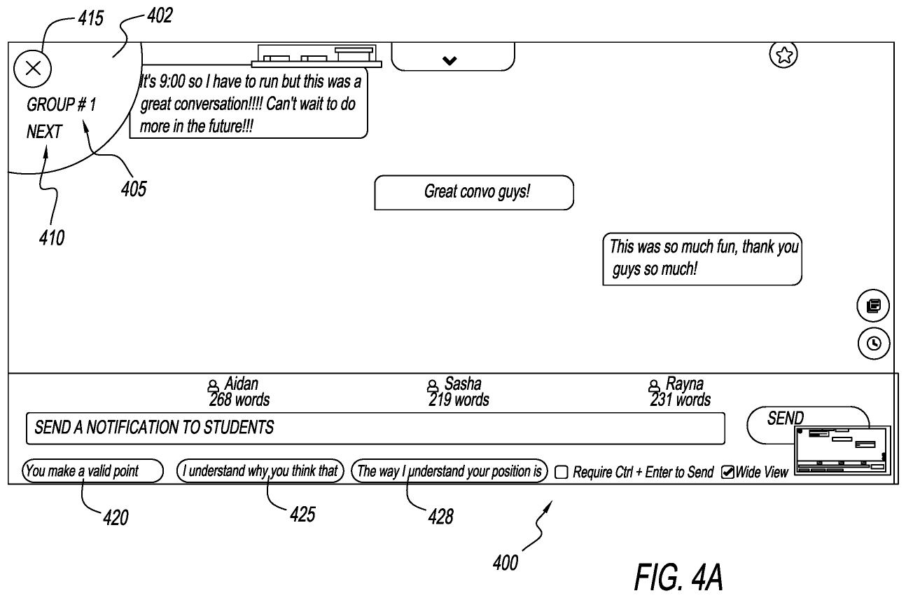

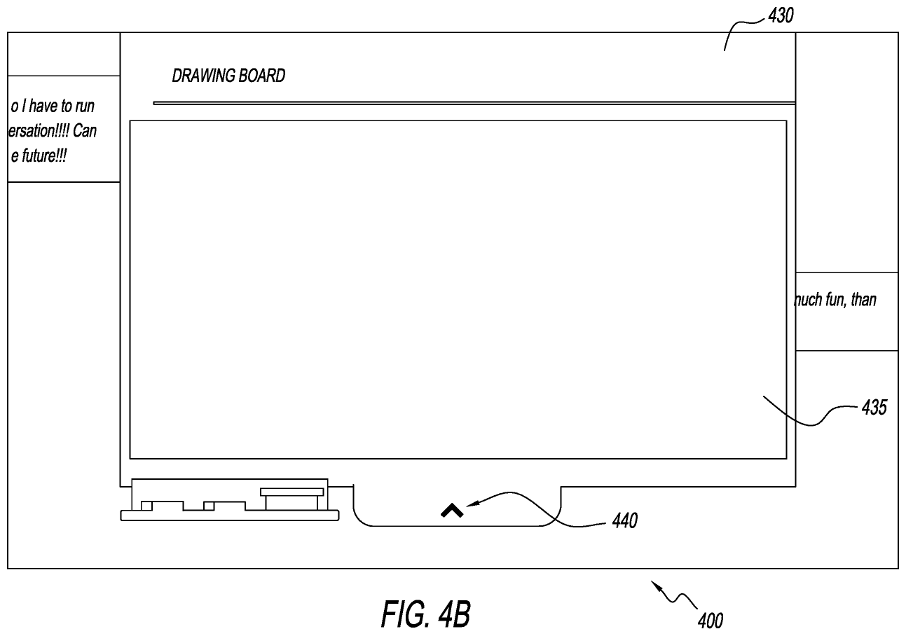

Referring to FIGS. 3-4B, user interface screens 300, 400 displaying a virtual conversation room are provided. A virtual conversation room feature may be utilized in order to complete assignments that require discourse around a chosen topic. The virtual conversation room may include between two to five users and is generally enhanced with features aimed at students and educators. Typically, each conversation room will include at least one educator. However, it will be appreciated that in other embodiments, students may hold conversations among themselves. The virtual conversation room includes a number of features accessible to all users. Such features may include intuitive messaging/conversing features that facilitate thoughtful, civil and informative conversation between the virtual conversation room participants.

Once in the virtual conversation room, the user may view each virtual conversation room user's name (e.g., “Aidan” 305), status, and a corresponding visual indicator of the status (e.g., gray for absence, or full of color for presence) to the user. The system may further display the corresponding number of words (e.g., “268 words” 310) contributed by each of the virtual conversation room users, positioned under the name.

The system may further display a message 315 corresponding to one user in a different color than messages corresponding to the other users, and each user's messages may be situated within a distinct designated section (e.g., a column) of the virtual conversation room directly aligned with their name (e.g., above their name, below their name, etc.), such that the user can easily identify each message's sender and view the history of messages of each user, while also following and contributing to the flow of the conversation. For example, as shown, each of the names of the users in the conversation room are in a column with the messages they send (e.g., Aidan's name 305 is aligned below his message 315). As such, the user is able to visually keep track of up to five streams of text while utilizing minimal scrolling. To send a message, a user may type a message in a text box 320 and select the send button 325. The user may further select an option 365 to select to require messages to be sent only after selecting a combination of buttons (e.g., “Require Ctrl+Enter to send”). The user may also select an option 330 to view the conversation room as a wide view, in which the system displays all columns of the conversation on the screen. If the option 330 is not selected, the conversation may instead display only a portion of the conversation on the screen.

The user may further be able to hover over a message 335 sent in the virtual conversation room in order to access a lightbulb icon 340 and a star icon 345 located below the text of the message. Should a user require clarification for the message, the user may select the lightbulb icon 340. Once the user has gained clarification regarding the message, the user may then highlight the lightbulb icon to indicate that the message was clarified. Should a user find the message insightful or interesting, the user may activate the star icon 345 in order to highlight the message and save it for later to review. The action of activating either the light bulb or the star icon is shared live among all users via a websocket connection to the server.

The user may also select a group icon 350 to view the conversation room number he is in and/or toggle between more than one virtual conversation rooms they have joined, as discussed further below with respect to FIG. 4A.

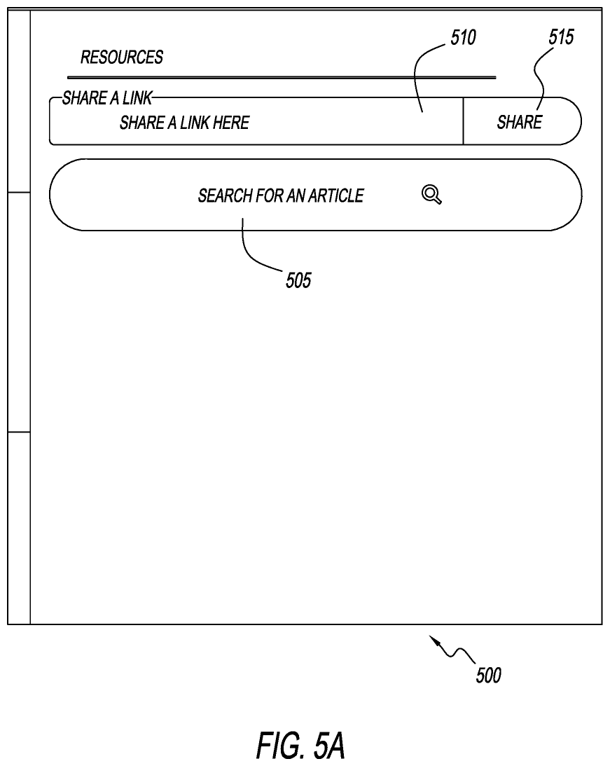

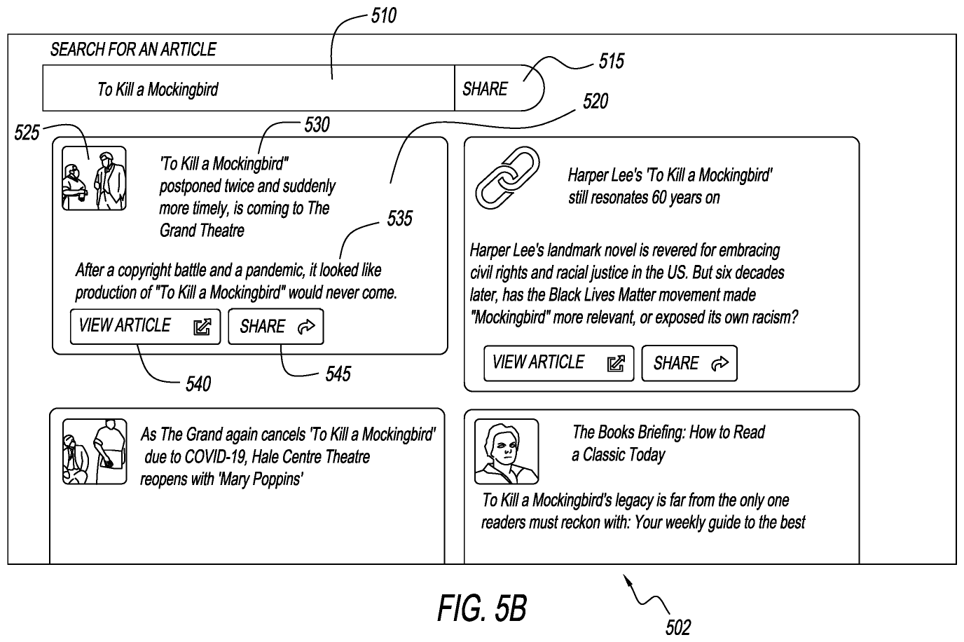

As will be discussed further below with respect to FIG. 4B, the user may select a drawing board icon (not shown) in order to access a drawing board within the virtual conversation room. Furthermore, as will be discussed further below with respect to FIGS. 5A-5B, the user may select a resource board icon 355 in order to access a resource board within the virtual conversation room.

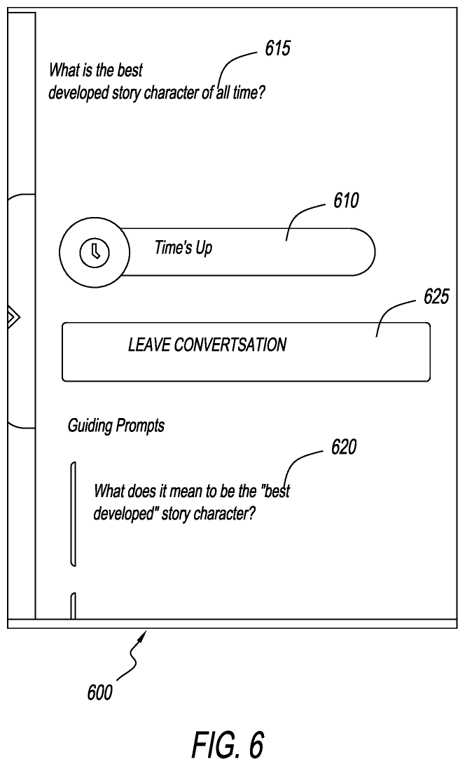

As will be discussed further below with respect to FIG. 6, the user may select a time icon 360 in order to bring up a pop-up screen within the chat displaying the time left in the conversation, the guiding prompt(s) of the conversation, (e.g., “What is the best developed story character of all time?”) and a link to leave the conversation.

The educator view of the chat room screen may be substantially similar to the student view of the conversation room screen, except that the instructor's message box 320 may read: “SEND A NOTIFICATION TO STUDENTS.”

Referring to FIG. 4A, as discussed above with respect to FIG. 3, generally, the user may be able to join more than one virtual conversation room. However, in certain embodiments, the user may view only one conversation room at a time. In such embodiments, the user may toggle between the virtual conversation rooms that he has joined to view the conversation room desired. As shown, the user may select or hover over a group link/icon 350 (from FIG. 3) which will bring up a pop-up window 402 showing the conversation room number that he is in (e.g., “Group #1” 405), a link 410 to view the next conversation room that he is in, and an option 415 to exit out of the pop-up window 402.

The system may further recommend, to the user, messages to send during the virtual conversation. This feature allows the user to adapt and learn from the system-generated message(s). The system may, in certain embodiments, analyze both a message that the user has typed out in the message box and the previous message in the conversation and recommend to the user a better, more open-minded way to express user's message with one or more system-generated messages. In cases where the user has not typed out a message yet, such as in the embodiments shown, the system may also offer default responses below the message box (e.g., “You make a valid point” 420 or “I understand why you think that” 425). In certain embodiments, such as the one shown, the system may also show responses that require completion from the user, for example “The way I understand your position is” 428, which requires the user to complete the sentence. The user may select one of the default responses, which would automatically appear in the message box and/or automatically be sent.

Such recommendations may be generated by the system through the use of artificial intelligence by preprocessing data and extracting features. First, a conversation preprocessor component processes the raw data of a conversation's history (and additional metadata) into a form that is usable by other components (e.g., the constraint feature extractor). Then, an attitude feature extractor and a constraint feature extractor component run several feature extraction functions on the data that is preprocessed by the conversation preprocessor component. The attitude feature extractor also includes attitude tags on the extracted data. Each function run by the attitude feature extractor identifies whether a user should be encouraged to adopt a specific attitude, and each function run by the constraint feature extractor is designed to identify whether the conversation has invoked one or more constraints.

Constraints include those relating to profanity, toxicity, and relevancy (e.g., constraints on specific words or phrases). Invoking a constraint generally means that the system will limit and/or filter the kinds of responses that the user who invoked the constraint may make. A system logic component analyzes whether the constraint feature extractor has detected any constraints on a user from the user's conversation history data. If the system logic component does detect a constraint, then the system logic component will generate a list of features that satisfy the constraint, sort by attitude tags (e.g., tags regarding the level of positivity or negativity), then return the top three phrases. If multiple constraints are invoked, the system logic component will take the one with the most precedence, as defined by a constraint precedence. If the system logic component does not detect any constraints on a user from the user's conversation history data, it then splits the phrases generated by the recommender into three lists, one for each possible action with regards to the latest sent message (e.g., “develop,” “question,” “contrast”). A recommender component calls the conversation preprocessor component to preprocess the data and the attitude and constraint feature extractor components to extract features. The recommender component then generates sentence suggestions according to the constraints that have been invoked. The sentence suggestions may be sorted by attitude tags in order from most positive to most negative.

Referring to FIG. 4B, a drawing board screen 430 is provided. Generally, the drawing board feature allows users to express and depict their ideas visually (e.g., by way of drawings) and share these ideas with the group. It also provides educators with a space to share resources for the students to analyze. Such resources include artwork, videos, PowerPoint presentations, etc. Once a drawing board icon is selected, a drawing board screen 430 displaying a blank drawing board may then appear as a pop-up within the user's conversation room screen 400. The user may then draw, add, or share resources to the drawing board by either dragging resources onto or “drawing” on the blank portion 435 of the drawing board (e.g., via clicking and dragging). Upon completion, the information provided by the user is then transmitted to all users in the virtual conversation room. The user may then minimize the drawing board via a minimize link 440 such that the user is able to view the conversation room screen 400 again. In exemplary embodiments, the resources are shared via a websocket connection to the server.

Referring to FIGS. 5A-5B, a resource board share screen 500 and a resource board search screen 502 are provided. As discussed above with respect to FIG. 3A, the user may also utilize a resource board feature provided in the virtual conversation room by selecting the resource board icon 355 within the virtual conversation room screen. Generally, the resource board share screen 500 and search screen 502 allow users to search for online resources, upload resources (e.g., documents, news articles, photos, videos, charts, etc.), and/or share one or more links to online resources (e.g., articles) support their claims and to learn more about the chat room conversation topic. Thus, importantly, the resource board encourages the exchange of evidence-based dialogue, thus promoting productive and thoughtful conversation. As shown, to share a link to an online resource, the user may input a URL in a freeform text box 510 provided by the resource board. Once the user adds the link and clicks the “Share” button 515, the shared link will be sent as a message in the virtual conversation room that other users in the conversation room can easily view and quote from.

If, on the other hand, the user wishes to search for an online resource to share, the user may select an icon 505 to search for an online resource, which may then navigate the user to a resource board search screen 502 (FIG. 5B). This screen allows the user to input a search query (e.g., “To Kill a Mockingbird”) into a freeform text box 510 and then click a button 515 to conduct the search. The system then conducts the search and returns all relevant results. In the embodiment shown where the search results are in the form of online articles, the system displays, for each result (e.g., article 520), a thumbnail 525, title 530, a brief preview 535, a link to view the entire article 540, a link to share the article 545, and a link to quote the article (not shown). In the described embodiments, the search feature conducts its search functionality by performing a meta-search on a variety news provider APIs, allowing for a cross-stream of informative searches.

Referring to FIG. 6, a time remaining screen 600 is displayed. As discussed above with regards to FIG. 3, the user may select a time icon 360 in order to bring up the time remaining screen within the conversation room displaying the amount of time left in the conversation 610 (e.g., “Time's Up”), the assignment 615, (e.g., “What is the best developed story character of all time?”), one or more guiding prompts 620 (e.g., “What does it mean to be the ‘best developed’ story character?”) and a link 625 to leave the conversation. Generally, the time constraint of the conversations (e.g., 1 hour) is set manually (e.g., by the educator) or automatically by the system.

Generally, the described embodiments may include certain virtual conversation room features that can be accessed and changed by only a select group of users (e.g., educators). The settings of such features may alternatively be automatically determined by the system and unable to be changed. Such features include creating and adjusting filters, creating and viewing classes and assignments, creating groups for virtual conversation rooms, tools for collaborating with other educators on assignments, analyzing conversation reports, etc. Such features are described in detail below.

In one embodiment, filters may be created and customized (e.g., by an educator) and may allow for flagging and blocking certain messages (e.g., profane and/or toxic messages) without an educator's presence. In such embodiments where the filter is customizable and manually set, educators may be able to decide whether to fully block all flagged messages, provide a warning, or remain hands off. In certain embodiments, the profanity filtering feature is powered by utilizing regular expressions to cross-reference messages with a regularly updated blacklist. The toxicity filtering feature is powered by utilizing an external sentiment analysis API.

Educators are generally able to create new classes, create assignments for the classes, invite students to a conversation room for the purpose of completing an assignment or other reason, and analyze conversation reports. Specifically, once an educator logs into the platform, they will be navigated to a landing page screen.

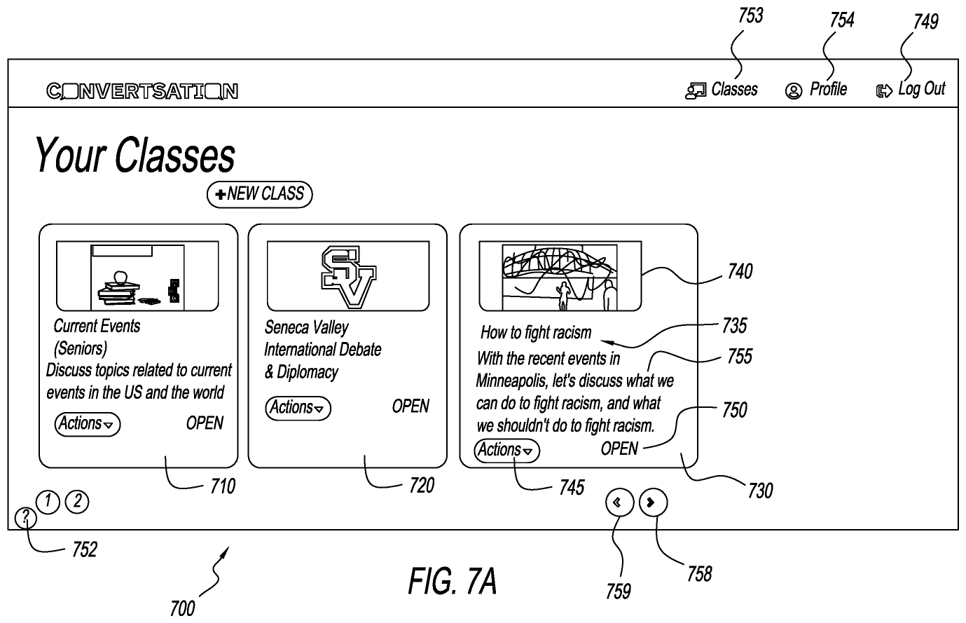

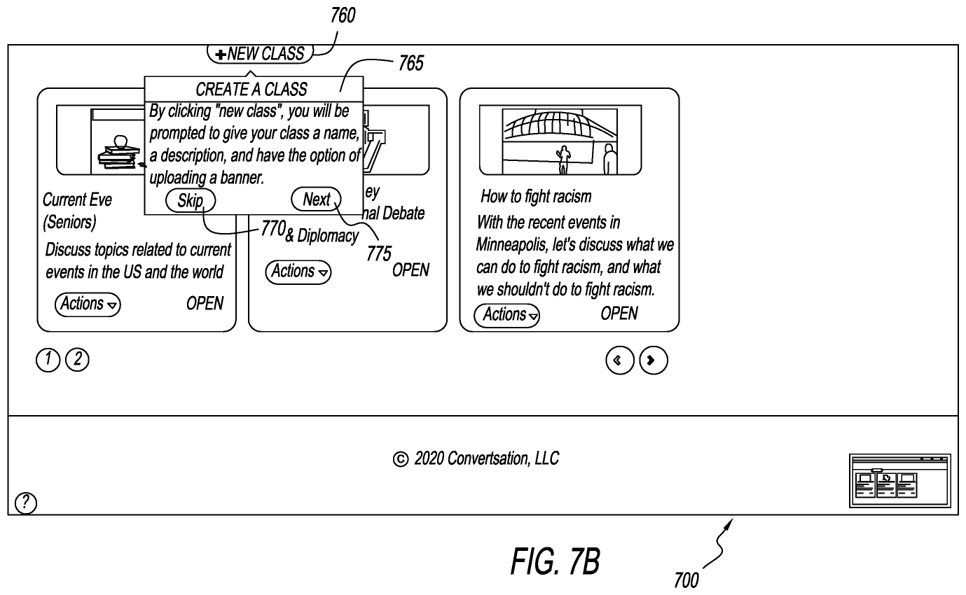

Referring to FIGS. 7A-7B, a landing page screen 700 is displayed. The landing page screen 700 shows a list of existing classes the educator has created. It also displays the current window that the educator is viewing 753, a link to access the educator's profile 754, and an link to log out of the platform 749. As shown, the existing classes may be displayed in the form of one or more thumbnails 710, 720, 730. Such thumbnails may include a class name 735 (e.g., “How to fight racism”), a visual banner representing the class 740, a drop-down list 745 of actions to take regarding the class (e.g., delete), a link 750 to open the class, and a description of the class 755 (e.g., “With the recent events in Minneapolis, let's discuss what we can do to fight racism, and what we shouldn't do to fight racism.”). The educator may also request help via a help link 752, navigate to the next page of classes via a forward link 758, or navigate to the previous page of classes via a previous link 759. The educator may also select a class to highlight it. Although not shown, once highlighted, a pop-up text box may appear under the class with guidance on how to navigate the landing page and create a new class (e.g., “View Your Class—Once you have created your class, it will appear in the directory, and you can copy the course code to allow your students to join. Clicking into it will enable you to create assignments for your class.”)

Furthermore, the educator may also conduct a search among all existing classes and assignments on the platform via a search form. Generally, the platform facilitates communication and discussion between all educators on the platform. Thus, if the educator finds an interesting class or assignment taught by another educator, they can select a link to connect with the other educator who teaches the class to host a collaboration. Both educators must click to confirm that they agree to connect their classes in an assignment, and then they can collaborate to build the assignment (e.g., creating prompts, a description, a title, groups, etc.).

The educator may create a new class by selecting a new class creation link 760. While hovering over the new class creation link, a pop-up text box 765 will appear to provide a tour of how to create the new class (e.g., by providing information on what the educator will need to provide to create the class). For example, in the embodiment shown, the pop-up text box 765 may include the following text: “By clicking ‘new class’ you will be prompted to give your class a name, a description, and have the option of uploading a banner.” The pop-up text box may further include a link 770 allowing the educator to skip the tour and a link 775 to continue to the next portion of the tour.

Although not shown, in certain embodiments, once the educator selects the new class creation link, a new class creation screen may appear as a pop-up window from the landing page. The new class creation screen may include blank text forms requiring the educator to provide a class name, a class description, and a blank upload box to drag-and-drop, or upload, a class banner image. In such embodiments, the uploading of a class banner image may be optional. Once the educator inputs at least a class name and description, he may select a link to submit the information and/or a link to close the new class creation screen.

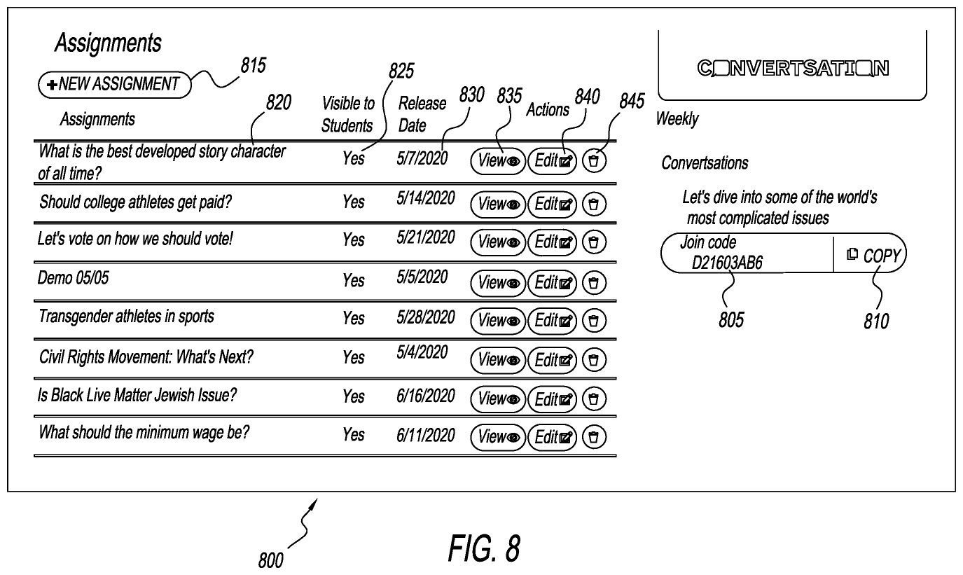

Referring to FIG. 8, an assignments screen 800 is displayed. Upon the creation of a new class by the educator, the system generates a course code 805 for the educator. The educator may select a link 810 to copy and share the course code with their students. Although not shown, once the students join the class, the educator may also be able to view a screen including a list of the class members, sorted by first name and last name.

Once the educator has created a new class and has invited their students to join the class, they can create one or more assignments for the class from the same assignments screen 800 by selecting a new assignment link 815, which is adapted for allowing educators to easily and quickly create impactful assignments within minutes.

The educator can also view all created assignments information on the assignment screen. As shown, the created assignments information for an assignment includes: assignment name 820 (e.g., “What is the best developed story character of all time?”) which may also be a link to access the assignment, whether the assignment is visible to students 825 (e.g., “yes”), assignment release date 830, and actions available to take regarding the assignment (e.g., view 835, edit 840, delete 845, etc.)

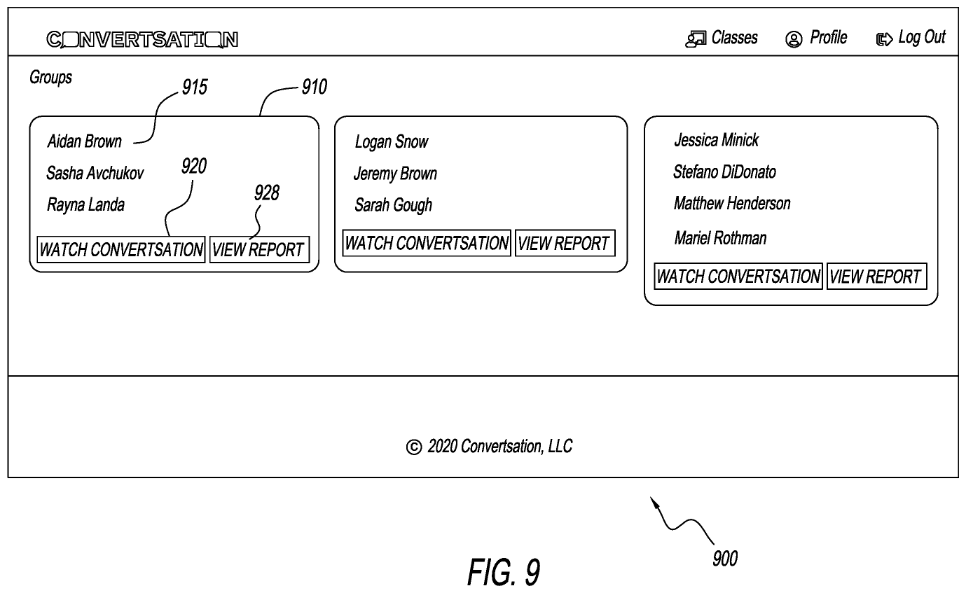

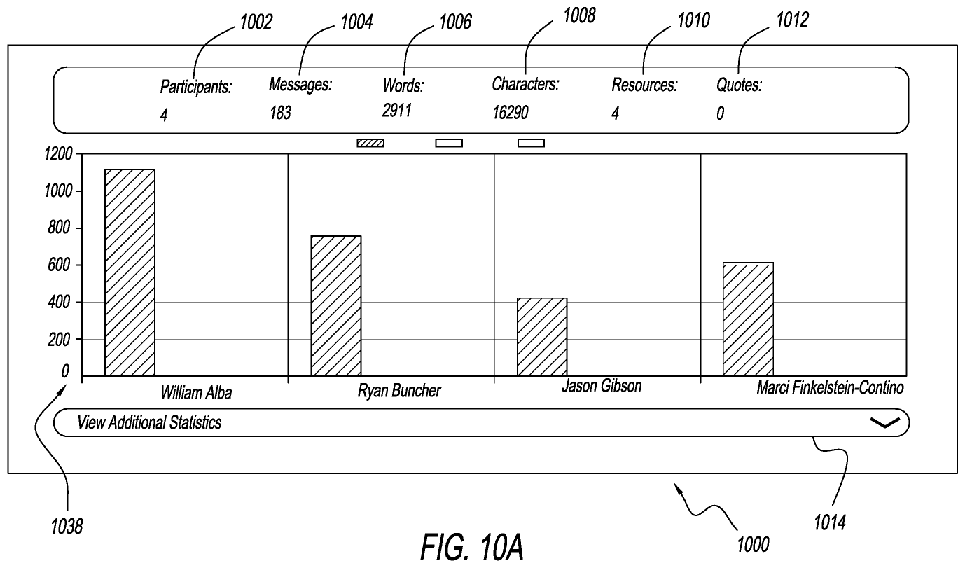

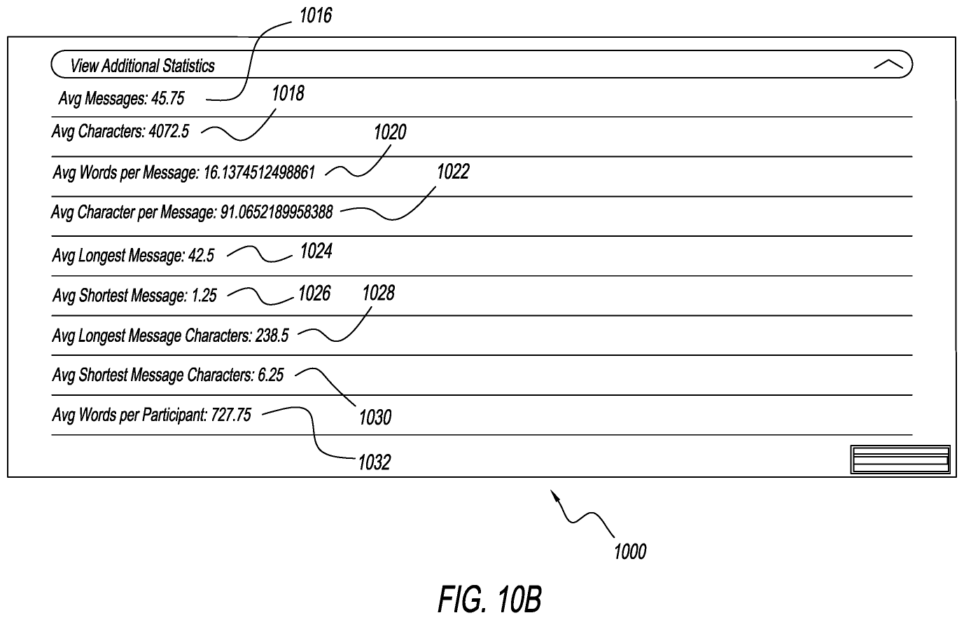

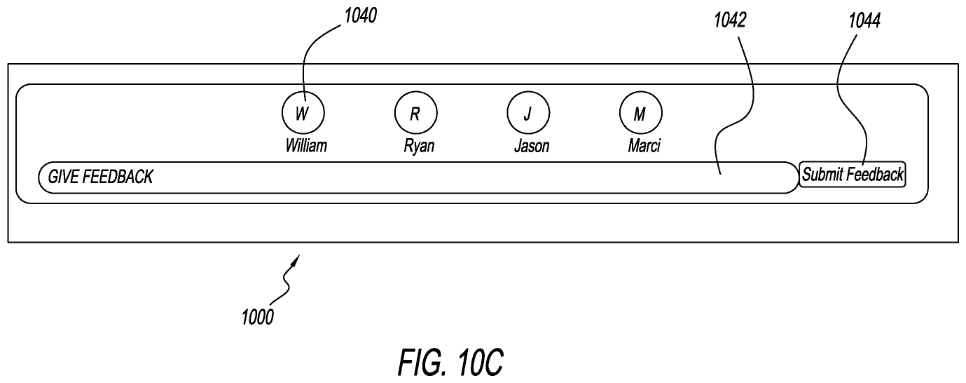

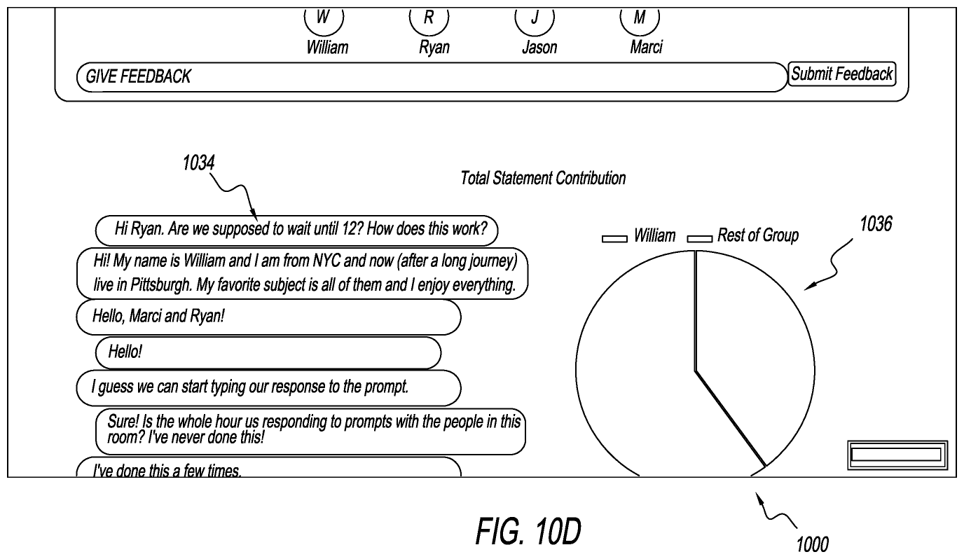

Referring to FIG. 9, a conversation room groups screen 900 for created assignments is displayed. As discussed above, the educator may create one or more groups of two to five students for the purpose of completing assignments in virtual conversation rooms. Such groups may be created either manually or randomly. In the embodiments described, to create a group manually, the educator may drag bubbles which contain student names into groups on the page. Additionally, although not shown, the educator can duplicate groups from a previous assignment by selecting a “Duplicate” button. Upon the creation of the one or more groups, the educator may be able to view all groups under the groups screen. Each group may be represented by a box 910 including all group members (e.g., “Aidan Brown” 915), a link 920 to watch the virtual conversation taking place in the virtual conversation room group, and a link 928 to view the conversation report for the room (discussed in more detail below with regards to FIGS. 10A-10D).

The educator may also create custom prompts which appear at set times during the virtual conversation. The educator may plan when prompts appear during the course of the conversation by dragging the handles of a slider bar that represent when each prompt will be displayed. During the course of a virtual conversation, users will see these prompts displayed within the chat interface at the time of the assignment, and such prompts will also remain permanently accessible both in the chat and via a student dashboard that displays remaining time in the conversation.

The system may further allow educators to post their upcoming assignments, conversation assignment templates, and other educational resources on the platform for other educators to view and connect with, providing their students with new perspectives from backgrounds all over the world.

Referring to FIGS. 10A-10D, a conversation reports screen 1000 is provided. Generally, conversation reports may be accessible to only a subset of the users on the platform, such as the educators. The reports display time-series graphs of different artificial intelligence- and natural language-backed metrics throughout and after a virtual conversation. As such, these conversation reports provide educators with a high level of accountability for their students. Referring to FIG. 10A, information displayed on the main conversation reports screen includes: number of participants 1002, total number of messages 1004, total words 1006, total number of characters 1008, total resources shared 1010, and total quotes 1012.

The conversation report metrics may be shown via text, or visually represented, for example, by means of one or more graphs. Metrics shown through graphs include, but are not limited to: number of messages sent over time, toxicity of the conversation over time, each user's word/character count, each user's number of quotes, number of resources shared by each user, each user's number of messages, each user's message highlights, number of resources shared by each user, number of times the star button was selected for each user, open-mindedness of the conversation over time, etc. The metrics may be displayed using bar graphs, pie graphs, line graphs etc. For example, as shown in FIG. 10A, the word count for each user during the conversation may be displayed a bar graph chart 1038. As shown, for example, William Alba has contributed around 1100 words to the conversation. As another example, as shown by FIG. 10D, the metric of the percentage of characters a user has contributed to the conversation may be depicted by a pie graph 1036 showing the proportion of words contributed by an individual user (e.g., William Alba) versus the rest of the group. The conversation report screen may also display all messages contributed by the individual user (e.g., “Hi Ryan. Are we supposed to wait until 12? How does this work?” 1034). These graphs may be overlaid with the respective prompt that was active during each partition of the duration of the conversation. Such graphs may be on the individual level and group level alike.

As shown in FIG. 10B, the user may select a link to view additional statistics 1014, which may then expand the screen to include additional metrics gathered by the system. The additional statistics include but are not limited to: average number of messages 1016, average characters 1018, average words per message 1020, average characters per message 1022, average longest message 1024, average shortest message 1026, average longest message characters 1028, average shortest message characters 1030, and average words per participant 1032.

In one embodiment, the screen 1000 may further include conversation highlights (e.g., messages with the highest amount of engagement during the conversation), relevancy score (i.e. how relevant each respective user's messages were to the conversation), user toxicity score, conversation score (i.e. the overall score of a conversation and/or a user's contribution to a conversation), summary of the conversation, whether a specific prompt generates negative emotions from students in the aggregate, etc.

It will be appreciated that the system may allow educators to configure the weights given to different sub-scores, apply curves, minimums, maximums, rubrics, or even manually adjust grades. And the invention's AI components can use educator adjustments to scores as inputs to improve the scoring process. Details regarding how the scores are calculated (e.g., relevancy score, user toxicity score, conversation score, etc.) are discussed in further detail with respect to FIG. 10C below.

The conversation reports may further allow educators to gain insight into student behaviors and outcomes by providing analytics regarding toxicity, profanity, contribution, and relevancy. Such analysis compares members of the same group, as well as different groups within the same assignment. While certain such reports are provided during the conversation, others may only be provided post-conversation. For example, the relevancy score is generally calculated automatically after the conversation is completed, based on entire comment history of the conversation.

Referring to FIG. 10C, the screen may also include a personalized feedback dashboard portion adapted to allow educators to provide students individualized feedback to support their learning and growth based on the virtual chat room conversation's analytics. As shown, a user accessing the personalized feedback dashboard may select a participant (e.g., “William” 1040) from a virtual conversation room group and provide feedback to the participant via a freeform text box 1042 and select a link 1044 to submit the feedback. This feedback is then sent to the participant in the form of a message. Thus, educators are able to send messages to students while viewing statistics of each of the other students' respective performances. In other embodiments, the system may automatically offer feedback to students if the students' scores cross a certain threshold or fall out of a certain range. For example, the algorithm assesses what percentage of the characters a user has contributed to the discussion to create a participation score. This participation score is scaled by the time in which the messages were sent. Characters from messages sent earlier in the conversation are weighted less towards the score than characters from more recent messages. Once the participation score drops below a threshold, the platform encourages the student to contribute more. On the other hand, if a student has too high of a participation score, they are encouraged to allow other students to contribute.

The system may also monitor metrics on the virtual conversation on the group level and automatically offer feedback in a similar manner. For example, if the toxicity score of a group rises above a certain threshold, the system may automatically suggest that the group members try to be more positive if full groups devolve into negativity.

While in the described embodiments, the virtual conversation rooms may be adapted for an education environment, in other embodiments, the embodiments can be accessible to the general public (e.g., via a publicly accessible website such as REDDIT for individuals to find people to discuss issues with each other). In such embodiments, the system may provide a curated list of topics, and either unregistered members of the public or anyone who is a member of the platform (e.g., with premium account levels) can register to join a virtual conversation to discuss a particular topic at a scheduled time, or in a less structured fashion, on a “walk-in” basis. Before the virtual conversation starts, the users may receive an email reminder or other notification including a link to the conversation. Upon selecting this link, the users are placed in a virtual conversation room with other people who signed up for the same topic. In such embodiments, users can self-moderate, and with a voting system, can remove a disruptive or rude user from the virtual conversation room.

### Analysis/Modeling of Participant Responses/Conversation

The system is able to track the ongoing development of a conversation, generate conversation reports including a large number of metrics, and build long-term statistics on users. Such analysis, scoring, and modeling of users' responses, participants, and conversations encourages and teaches constructive discussion skills. The metrics gathered by the system can be analyzed and used, by both the system and the educators, to recommend to users respectful and more open-minded ways to respond to other messages in the conversation. The analytics, scoring and modeling features rely on algorithms utilizing the PERSPECTIVE API and are improved by new data from conversations held within the platform via machine learning and AI algorithms and build long-term statistics on users. Generally, the system is able to analyze, score, and model conversations, topics, and users.

The system may be able to engage in topic analysis through the collection of a myriad of metrics. It may utilize such metrics to model across all groups participating in a single conversation. Specifically, the system may identify themes and topics discussed in each of the different groups and across different prompts, and the proportion of the conversation which included those themes and topics in the respective groups. The system further allows for the monitoring of the development of a conversation relative to the prompt at hand. This ensures that the topics discussed changes with the prompts, and further ensures that students follow the structure of the lesson. These metrics will be integrated with the conversation reports accessible by the instructor.

The metrics calculated by the system pertain to the individual user, full groups, and specific prompts. As an example, the system can determine whether a specific prompt evokes negative emotions from the conversation room group as a whole, or individual users. As discussed above, such metrics include: number of participants, total number of messages, total words, total number of characters, total resources shared, total quotes, average number of messages, average characters, average words per message, average characters per message, average longest message, average shortest message, average longest message characters, average shortest message characters, average words per participant, participant message highlights (e.g., messages with the highest amount of engagement), summary of the conversation, number of messages sent over time, toxicity of the conversation over time, open-mindedness of the conversation over time, etc. Individual metrics include each user's word/character count, each user's number of quotes, each user's number of messages, each user's message highlights, number of resources shared by each user, number of times the star button was selected for each user, etc.

As discussed above, a number of scores is further provided by the system. While certain metrics discussed above (e.g., individual metrics) may be assigned a score based on solely one factor, certain scores (e.g., the conversation score, the relevancy score, and the toxicity score) may be determined by combining various sub-scores of messages, conversations, a user's contribution, (e.g. relevancy, toxicity, open-mindedness, positivity, etc.), or other metrics into one or more weighted averages that represent a score for a conversation and/or a user's contribution to a conversation. As also discussed above, instructors can configure the weights given to different sub-scores, apply curves, minimums, maximums, rubrics, or even manually adjust grades. The invention's AI components can use instructor adjustments to scores as inputs to improve the scoring process. This scoring feature allows educators to quickly make their own qualitative judgments about the quality of each student's contribution based on quantitative and qualitative data. These scores are determined using one or more metrics (e.g., each user's word/character count) discussed above.

For example, the relevancy score is calculated automatically after the conversation is completed, based on the entire comment history of the conversation. To assess the relevancy score, the system examines the messages sent during the period of time that a prompt is being displayed and measures how relevant the messages sent by each participant are to the prompt. Each individual comment is then scored. This returns the relevancy score for each participant for each prompt, an average conversation score for each participant, and the most relevant and least relevant messages from each participant. This system is implemented using Python natural language processing libraries. The relevancy score may further utilize one or more metrics such as each user's message highlights. For example, if a user has a high score for message highlights, this may be an indication that their comments were highly relevant. Similarly, if a user has a high score for the number of times the star button was selected for their comments, then that metric may also factor favorably into the relevancy score.

The toxicity and open-mindedness scores are calculated by analyzing each message sent on the platform for language, content, tone, responsiveness, keywords, and other metrics. The conversation score is calculated by combining a number of sub-scores, such as the scores given to individual metrics, scores given to all of the messages, and each user's toxicity, relevancy, and open-mindedness scores.

The metrics and scores discussed in the foregoing paragraphs may be collected over the long term to build a model of the user. Additional features may include the ability to take into account the context of messages and adjust for or remove bias in processing.

The system may collect metrics over the long term to model one or more characteristics of users. Such characteristics include: political leaning, general level of open-mindedness, overall attitude/level of positivity, sentence complexity, vocabulary, prevalence of toxic language, etc. This model will then be used to tailor sentence suggestions and resource suggestions to each user. This model also monitors the user's progression through the system. For example, the model will track whether the user begins to use/share more neutral news resources, whether the user is using less toxic language, etc.

The system's analytics/scoring/modeling features can be utilized as a standalone component to be used with compatible systems. For example, these features can also be utilized as an API for offering scoring of user input as a service. In such embodiments, the user may create an account, connect a credit card, and generate API keys. The user can then connect their software or application to the invention's backend service that can authenticate with these API keys and handle requests. At least the following API routes may be provided:
a. Scoring a single user's input: Given a JSON-formatted array of one or more messages from a user, the system will compute the open-mindedness, toxicity, persuasiveness and return the sub-scores; and
b. Scoring a back-and-forth conversation between multiple people: Given an ordered JSON-formatted array of messages from multiple users, the system can compute the metrics described above for each student, and also track the responsiveness of each message to the other messages in the conversation.

These features can also be utilized as a plugin (e.g., a WORDPRESS or a REDDIT plugin) to analyze and score messages. In embodiments where the features are utilized as a WORDPRESS plugin, the invention's APIs may be used to analyze WORDPRESS forums and comment sections. The user would install the WORDPRESS plugin, purchase an API key, and add it to the WORDPRESS plugin settings. The plugin would then automatically scan comments to assign scores. The WORDPRESS administrator would choose how these scores are used/displayed. The WORDPRESS plugin exists as an extension of the above API offering, using it as a dependency.

In embodiments where the features are utilized as a REDDIT plugin, a user wishing to use the invention's API to analyze Reddit threads may install the plugin, which is available as a Chrome/Firefox/Edge/Safari/other browser extension, and sign into their API account. The browser extension authenticates with the user's API account to manage access to the service. The browser extension scans a REDDIT thread, uploads the messages to the API as a JSON array, and receives the API response with computed scores for the metrics. These metrics are displayed on the REDDIT page in-line with the comments of the thread, which the user may view. The metrics are also stored in the system's database and are loaded later in a dashboard page accessible via the plugin menu. The user is also able to access this dashboard page, which shows various trends and highlights.

The system may include a number of additional powerful analytical features, including a personified instructor, external resource analysis, and interpretable classification.

Although not shown, the described embodiments may include a personified instructor component which automatically analyzes all of the participant/student-facing AI and analytics features (e.g., phrase suggestions, profanity and toxicity filtering, and the student-facing reports page) and provides feedback and guidance within the platform. The personified instructor component may also include a chatbot component, which is able to engage with users in a conversational manner. The personified instructor component may also exist outside of the platform as a browser extension. In such embodiments, the personified instructor component may provide suggestions for posts and comments users write on platforms, such as social media platforms and email platforms.

The described embodiments may also include an external resource analysis component adapted to automatically analyze a source's potential biases. Generally, when a user uploads a link to a news article via the resource library of the platform, the system runs an analysis on the article based on a pre-trained machine learning model. The model returns a computed credibility score that is used in the web UI. If the credibility score is below a certain threshold, users will be warned that the article may not be credible via an alert. The component may then suggest other articles on the same topic with the opposite bias.

The external resource analysis component may also automatically classify documents in terms of biases and provide details regarding the biases. For example, the system may determine and display the level of bias the documents exhibit (e.g., high bias, medium bias, low bias, neutral), and how the documents are biased (e.g., left-leaning, right-leaning, etc.)

In order to analyze the documents, the external resource analysis component may be adapted to leverage open-source bias datasets and a custom neural network architecture. While described herein as a component of the conversation system, the external resource analysis component may also be available as a browser extension to analyze biases in any webpage.

Although not shown, the described embodiments further include systems and methods that provide an API for scoring the quality of a new article. Users may rate or otherwise offer feedback on the quality of an article. Options might include “outdated,” “no primary sources,” “undisclosed bias,” “well written,” “neutral point of view,” “peer-reviewed,” “cites sources,” etc. This feedback information is used in conjunction with the article text and metadata (e.g., author, website domain, article date, title, etc.) to build models that rate the quality of a resource. The described embodiments further allow users to submit a news article URL to the API and receive scores on its quality. This feature exists as an extension to the API-offering service. The resource quality analyzer is a separate API route that is authenticated by the API key generated by a user in their portal. The API route accepts a URL to the article to be analyzed and computes the credibility scores based on an internal machine learning model. Additionally, this API is served as a browser extension product that utilizes this API whenever the user visits a news article website (e.g., by sending the URL to the API), and uses the response to display an overlay on the webpage that shows the credibility score.

Although not shown, the described embodiments further include AI systems and methods that are adapted to provide explanations for its decisions utilizing selective rationalization used in natural language processing (“NLP”) systems to assign a weight to each word in an input sentence or phrase of a classifier, which represents the importance of the word to the system's final decision. This will be usable with powerful neural architectures, including those that leverage attention.

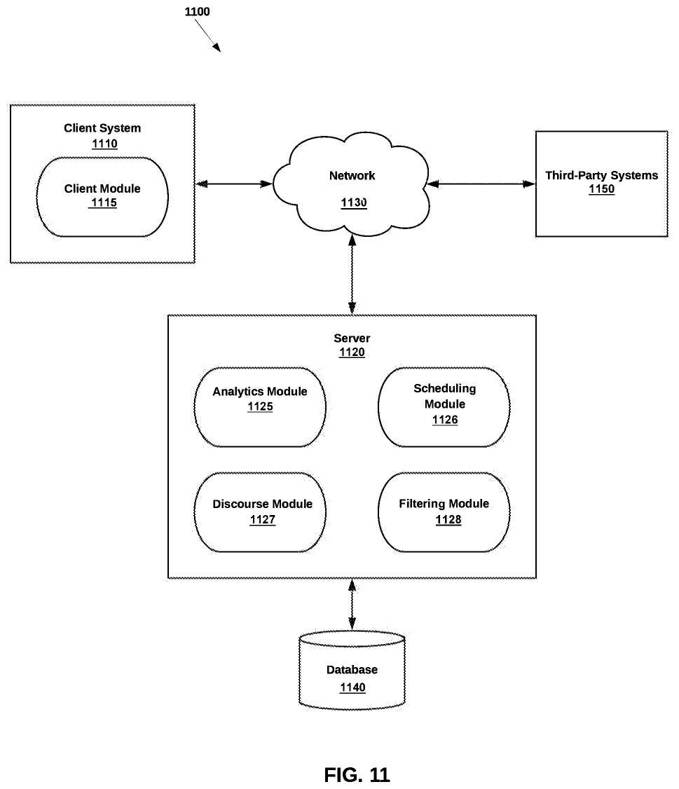

Referring to FIG. 11, a block diagram depicting an online discourse system 1100 in accordance with one or more embodiments is illustrated. As shown, the system may comprise one or more client devices and/or client systems 1110 interfacing with a server 1120 that transmits and/or receives data to/from a database 1140. Each of the client system 1110, the server 1120 and the database 1140 may communicate over one or more networks (e.g., network 1130).

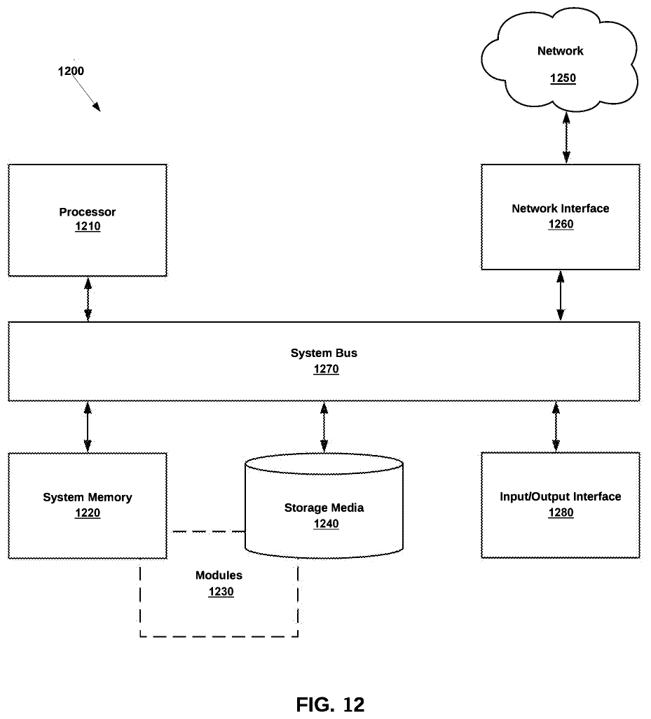

As detailed below in reference to FIG. 12, the server 1120 may comprise any number of computing machines and associated hardware/software, where each computing machine may be located at one site or distributed across multiple sites and interconnected by a communication network. The server 1120 may provide the backend functionality of the online discourse system 100.

To that end, the server 1120 may execute a multitenant discourse platform comprising various modules, such as an analytics module 1125, a scheduling module 1126, a discourse module 1127, and a filtering module 1128. The discourse platform may be adapted to present various user interfaces to users, where such interfaces may be based on information stored on a client system 1110 and/or received from the server 1120. The discourse application may be written in any form of programming language, including compiled or interpreted languages, or declarative or procedural languages, and it can be deployed in any form, including as a standalone program or as a module, component, subroutine, or other unit suitable for use in a computing environment. Such software may correspond to a file in a file system. A program can be stored in a portion of a file that holds other programs or data. For example, a program may include one or more scripts stored in a markup language document; in a single file dedicated to the program in question; or in multiple coordinated files (e.g., files that store one or more modules, sub programs, or portions of code).

Generally, client systems 1110 may comprise any systems or devices capable of running a client module 1115 and/or of accessing the server 1120. As discussed below in reference to FIG. 12, exemplary client systems 1110 may comprise computing machines, such as general purpose desktop computers, laptop computers, tablets, smartphones wearable devices, virtual reality (“VR”) devices and/or augmented reality (“AR”) devices.

The client module 1115 may be adapted to communicate with the discourse application and/or the various modules running on the server 1120. Exemplary client modules 1115 may comprise a computer application, a native mobile application, a webapp, or software/firmware associated with a kiosk, set-top box, or other embedded computing machine. In one embodiment, a user may download an application comprising a client module 1115 to a client system (e.g., from the Google Play Store or Apple App Store). In another embodiment, a user may navigate to a webapp comprising a client module 1115 using an internet browser installed on a client system 1110.

The server 1120 and client systems 1110 may be adapted to receive and/or transmit application information to/from various users (e.g., via any of the above-listed modules). Such systems may be further adapted to store and/or retrieve application information to/from one or more local or remote databases (e.g., database 1140). Exemplary databases 1140 may store received data in one or more tables, such as but not limited to, a users table, a conversation metrics table, an assignments table, a user metrics table, a classes table, a groups table, and/or others.

Optionally, the discourse system 1100 may additionally comprise any number of third-party systems 1150 connected to the server 1120 via the network 1130. Third-party systems 1150 typically store information in one or more remote databases that may be accessed by the server 120. Third-party systems may include, but are not limited to: communication systems, location and navigation systems, scheduling systems, filtering systems, backup systems, analytics systems, and/or others. The server 1120 may be capable of retrieving and/or storing information from third-party systems 1150, with or without user interaction. Moreover, the server 1120 may be capable of communicating information (e.g., information stored in the database 1140) to any number of third-party systems, and may notify users of such communications.

Referring to FIG. 12, a block diagram is provided illustrating a computing machine 1200 and modules 1230 in accordance with one or more embodiments presented herein. The computing machine 1200 may correspond to any of the various computers, servers, mobile devices, embedded systems, or computing systems discussed herein. For example, the computing machine 1200 may correspond to the client systems 1110, server 1120 and/or third-party systems 1150 shown in FIG. 11.

A computing machine 1200 may comprise all kinds of apparatuses, devices, and machines for processing data, including but not limited to, a programmable processor, a computer, and/or multiple processors or computers. As shown, an exemplary computing machine 1200 may include various internal and/or attached components such as processor 1210, system bus 1270, system memory 1220, storage media 1240, input/output interface 1280, and network interface 1260 for communicating with a network 1250.

The computing machine 1200 may be implemented as a conventional computer system, an embedded controller, a laptop, a server, a mobile device, a smartphone, a set-top box, over-the-top content TV (“OTT TV”), Internet Protocol television (“IPTV”), a kiosk, a vehicular information system, one more processors associated with a television, a customized machine, any other hardware platform and/or combinations thereof. Moreover, a computing machine may be embedded in another device, such as but not limited to, a mobile telephone, a personal digital assistant (“PDA”), a smartphone, a tablet, a mobile audio or video player, a game console, a Global Positioning System (“GPS”) receiver, or a portable storage device (e.g., a universal serial bus (“USB”) flash drive). In some embodiments, the computing machine 1200 may be a distributed system configured to function using multiple computing machines interconnected via a data network or bus system 1270.

The processor 1210 may be configured to execute code or instructions to perform the operations and functionality described herein, manage request flow and address mappings, and to perform calculations and generate commands. The processor 1210 may be configured to monitor and control the operation of the components in the computing machine 1200. The processor 1210 may be a general-purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 1210 may be a single processing unit, multiple processing units, a single processing core, multiple processing cores, special purpose processing cores, coprocessors, or any combination thereof. In addition to hardware, exemplary apparatuses may comprise code that creates an execution environment for the computer program (e.g., code that constitutes one or more of: processor firmware, a protocol stack, a database management system, an operating system, and a combination thereof). According to certain embodiments, the processor 1210 and/or other components of the computing machine 1200 may be a virtualized computing machine executing within one or more other computing machines.

The system memory 1220 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 1220 also may include volatile memories, such as random access memory (“RAM”), static random access memory (“SRAM”), dynamic random access memory (“DRAM”), and synchronous dynamic random access memory (“SDRAM”). Other types of RAM also may be used to implement the system memory. The system memory 1220 may be implemented using a single memory module or multiple memory modules. While the system memory is depicted as being part of the computing machine 1200, one skilled in the art will recognize that the system memory may be separate from the computing machine without departing from the scope of the subject technology. It should also be appreciated that the system memory may include, or operate in conjunction with, a non-volatile storage device such as the storage media 1240.

The storage media 1240 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 1240 may store one or more operating systems, application programs and program modules such as module, data, or any other information. The storage media may be part of, or connected to, the computing machine 1200. The storage media may also be part of one or more other computing machines that are in communication with the computing machine such as servers, database servers, cloud storage, network attached storage, and so forth.

The modules 1230 may comprise one or more hardware or software elements configured to facilitate the computing machine 1200 in performing the various methods and processing functions presented herein. The modules 1230 may include one or more sequences of instructions stored as software or firmware in association with the system memory 1220, the storage media 1240, or both. The modules 1230 may also comprise hardware circuits or information for configuring hardware circuits such as microcode or configuration information for an FPGA or other PLD. Exemplary modules include, but are not limited to, the modules discussed above with respect to FIG. 11 (e.g., the analytics module 1125, the scheduling module 1126, the discourse module 1127, and the filtering module 1128) or any other scripts, web content, software, firmware and/or hardware.

In one embodiment, the storage media 1240 may represent examples of machine or computer readable media on which instructions or code may be stored for execution by the processor. Machine or computer readable media may generally refer to any medium or media used to provide instructions to the processor. Such machine or computer readable media associated with the modules may comprise a computer software product. It should be appreciated that a computer software product comprising the modules may also be associated with one or more processes or methods for delivering the module to the computing machine via the network, any signal-bearing medium, or any other communication or delivery technology.

The input/output (“I/O”) interface 1280 may be configured to couple to one or more external devices, to receive data from the one or more external devices, and to send data to the one or more external devices. Such external devices along with the various internal devices may also be known as peripheral devices. The I/O interface 1280 may include both electrical and physical connections for operably coupling the various peripheral devices to the computing machine 1200 or the processor 1210. The I/O interface 1280 may be configured to communicate data, addresses, and control signals between the peripheral devices, the computing machine, or the processor. The I/O interface 1280 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attachment (“ATA”), serial ATA (“SATA”), universal serial bus (“USB”), Thunderbolt, FireWire, various video buses, and the like. The I/O interface may be configured to implement only one interface or bus technology. Alternatively, the I/O interface may be configured to implement multiple interfaces or bus technologies. The I/O interface may be configured as part of, all of, or to operate in conjunction with, the system bus 1270. The I/O interface 1280 may include one or more buffers for buffering transmissions between one or more external devices, internal devices, the computing machine 1200, or the processor 1210.

The I/O interface 1280 may couple the computing machine 1200 to various input devices including mice, touch-screens, scanners, biometric readers, electronic digitizers, sensors, receivers, touchpads, trackballs, cameras, microphones, keyboards, any other pointing devices, or any combinations thereof. When coupled to the computing device, such input devices may receive input from a user in any form, including acoustic, speech, visual, or tactile input.

The I/O interface 1280 may couple the computing machine 1200 to various output devices such that feedback may be provided to a user via any form of sensory feedback (e.g., visual feedback, auditory feedback, or tactile feedback). For example, a computing device can interact with a user by sending documents to and receiving documents from a device that is used by the user (e.g., by sending web pages to a web browser on a user's client device in response to requests received from the web browser). Exemplary output devices may include, but are not limited to, displays, speakers, printers, projectors, tactile feedback devices, automation control, robotic components, actuators, motors, fans, solenoids, valves, pumps, transmitters, signal emitters, lights, and so forth. And exemplary displays include, but are not limited to, one or more of: projectors, cathode ray tube (“CRT”) monitors, liquid crystal displays (“LCD”), light-emitting diode (“LED”) monitors and/or organic light-emitting diode (“OLED”) monitors.

Embodiments of the subject matter described in this specification can be implemented in a computing machine 1200 that includes one or more of the following components: a backend component (e.g., a data server); a middleware component (e.g., an application server); a frontend component (e.g., a client computer having a graphical user interface (“GUI”) and/or a web browser through which a user can interact with an implementation of the subject matter described in this specification); and/or combinations thereof. The components of the system can be interconnected by any form or medium of digital data communication, such as but not limited to, a communication network.

Accordingly, the computing machine 1200 may operate in a networked environment using logical connections through the network interface 1260 to one or more other systems or computing machines 1200 across the network 1250. The network 1250 may include wide area networks (“WAN”), local area networks (“LAN”), intranets, the Internet, wireless access networks, wired networks, mobile networks, telephone networks, optical networks, or combinations thereof. The network 1250 may be packet switched, circuit switched, of any topology, and may use any communication protocol. Communication links within the network 1250 may involve various digital or an analog communication media such as fiber optic cables, free-space optics, waveguides, electrical conductors, wireless links, antennas, radio-frequency communications, and so forth.

The processor 1210 may be connected to the other elements of the computing machine 1200 or the various peripherals discussed herein through the system bus 1270. It should be appreciated that the system bus 1270 may be within the processor, outside the processor, or both. According to some embodiments, any of the processor 1210, the other elements of the computing machine 1200, or the various peripherals discussed herein may be integrated into a single device such as a system on chip (“SOC”), system on package (“SOP”), or ASIC device.

Reference in the specification to “one embodiment” or to “an embodiment” means that a particular feature, structure, or characteristic described in connection with the embodiment is included in at least one embodiment. The appearances of the phrase “in one embodiment” or “an embodiment” in various places in the specification are not necessarily all referring to the same embodiment.

Unless specifically stated otherwise as apparent from the following discussion, it is appreciated that throughout the description, discussions utilizing terms such as “processing” or “computing” or “calculating” or “determining” or “displaying” or “determining” or the life, refer to the action and processes of a computer system, or similar electronic computing device (such as a specific computing machine), That manipulates and transforms data represented as physical (electronic) quantities within the computing system memories or registers or other such information storage, transmission or display devices.

Certain aspects of the embodiments include process steps and instructions herein in the form of an algorithm. It should be noted that the process steps and instructions of the embodiments can be embodied in software, firmware or hardware, and when embodied in software, firmware or hardware, and when embodied in software could be downloaded to resided on and be operated from different platforms used by a variety of operating systems. The embodiments can also be in a computer program product, which can be executed on a computing system.

The embodiments also relate to an apparatus for performing the operations herein. This apparatus may be specially constructed for the purposes, e.g. a specific computer, or it may comprise a general-purpose computer selectively activated or reconfigured by a computer program stored in the computer. Such a computer program may be stored in a computer readable storage medium, such as but is not limited to, any type of disk including floppy disks, optical disks, CD-ROMs, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be transient or non-transient medium, where a non-transient or non-transitory medium can include memory/storage that stores information for more than a minimal duration. Furthermore, the computers referred to in the specifications may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for disclosure of enablement and best mode. While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments as defined in the appended claims.

Various embodiments are described in this specification, with reference to the detailed discussed above, the accompanying drawings, and the claims. Numerous specific details are described to provide a thorough understanding of various embodiments. However, in certain instances, well-known or conventional details are not described in order to provide a concise discussion. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the embodiments.

The embodiments described and claimed herein and drawings are illustrative and are not to be construed as limiting the embodiments. The subject matter of this specification is not to be limited in scope by the specific examples, as these examples are intended as illustrations of several aspects of the embodiments. Any equivalent examples are intended to be within the scope of the specification. Indeed, various modifications of the disclosed embodiments in addition to those shown and described herein will become apparent to those skilled in the art, and such modifications are also intended to fall within the scope of the appended claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

All references, including patents, patent applications and publications cited herein are incorporated herein by reference in their entirety and for all purposes to the same extent as if each individual publication or patent or patent application was specifically and individually indicated to be incorporated by reference in its entirety for all purposes.

What is claimed is:

1. A computer-implemented method for facilitating online discourse, comprising:
receiving, by a computer, from a user, class information associated with a class, the class information comprising a class name and a class description;
storing, by the computer, the class information;
receiving, by the computer, from the user, assignment information associated with an assignment, the assignment information comprising a requirement to participate in a virtual conversation relating to a topic;
storing, by the computer, the assignment information;
receiving, by the computer, from the user:
a request to create a first virtual conversation room and a second virtual conversation room,
wherein the first virtual conversation room and the second virtual conversation room are associated with the virtual conversation;
a request to place a second user in the first virtual conversation room;
a request to place a third user in the first virtual conversation room;
a request to place a fourth user in the second virtual conversation room; and
a request to place a fifth user in the second virtual conversation room;
displaying, by the computer, the class information, to the second user;
receiving, by the computer, a request from the second user to join the first virtual conversation room;
approving, by the computer, the request from the second user; and
displaying, by the computer, the first virtual conversation room to the second user.

2. The method of claim 1, further comprising
receiving, by the computer, one or more available times to join the virtual conversation, from the second user; and
determining, by the computer, a virtual conversation room for the second user based on the received one or more available times;

3. The method of claim 1, further comprising displaying, by the computer, a pre-conversation waiting room, to the second user.

4. The method of claim 1, further comprising:
receiving, by the computer, a message from the third user;
displaying, by the computer, to the second user, the message aligned with the third user's name;
receiving, by the computer, a second message from the second user; and
displaying, by the computer, to the third user, the second message aligned with the second user's name.

5. The method of claim 1, further comprising:
receiving, by the computer, a message from the third user;
analyzing, by the computer, the message;
displaying, by the computer, one or more recommended responses to the second user;
receiving, by the computer, from the second user, a selected recommended response from the one or more recommended responses and a request to send the selected recommended response to the first virtual conversation room; and
transmitting the recommended response to the third user.

6. The method of claim 5, wherein each of the message and the second message comprises a background, wherein the background of the message is a different color from the background of the second message.

7. The method of claim 1, further comprising:
receiving, by the computer, from the third user, a message; and
displaying, by the computer, to the first virtual conversation room, an option to request clarification on the message and an option to indicate that the message was interesting.

8. The method of claim 7, further comprising:
receiving, by the computer, from the second user, a selection of the option to request clarification on the message;
notifying, by the computer, to the first virtual conversation room, the selection of the option to request clarification on the message;
receiving, by the computer, a third message from the third user;
displaying, by the computer, the third message to the second user; and
receiving, by the second user, a second selection of the option to request clarification on the message,
wherein the second selection of the option to request clarification on the message indicates that the message has been clarified.

9. The method of claim 7, further comprising:
receiving, by the computer, from the second user, a selection of the option to indicate that the message was interesting;
saving the message, by the computer, for the second user; and
transmitting, by the computer, a notification of the selection of the option to indicate that the message was interesting, to the first virtual conversation room.

10. The method of claim 1, further comprising:
receiving, from the second user, a selection of an option display a drawing board, wherein
the drawing board is adapted to receive one or more visual resources from the user,
wherein the one or more visual resources comprise: artwork, videos, PowerPoint presentations, and drawings;
displaying, by the computer, to the second user, the drawing board;
receiving, by the computer, a visual resource from the second user; and
displaying, by the computer, the visual resource, to the first virtual conversation room.

11. The method of claim 1, further comprising:
receiving, from the second user, a selection of an option to display a resource board,
wherein the resource board is adapted to allow a user to search for an online resource or share an online resource to the first virtual conversation room.

12. The method of claim 1, further comprising:
creating, by the user, one or more filters for the virtual conversation,
wherein the one or more filters comprise toxicity filters and profanity filters.

13. The method of claim 1, further comprising:
receiving, by the computer, from the user, a request to view a conversation report relating to the virtual conversation; and
displaying, by the computer, the conversation report,
wherein the conversation report comprises one or more metrics relating to the virtual conversation selected from the group consisting of: number of users, total number of messages exchanged, total words exchanged, total number of characters exchanged, total resources shared, total quotes exchanged, average number of messages exchanged, average characters exchanged, average words per message, average characters per message, average longest message, average shortest message, average longest message characters, average shortest message characters, average words per user, messages with the highest amount of engagement during the virtual chat room conversation, a conversation summary, and whether a specific prompt generated negative emotions from users in the aggregate.

14. The method of claim 13, further comprising an external resource analysis component wherein the computer is adapted to analyze and determine the level of bias for shared or searched online resources.

15. The method of claim 1, further comprising calculating, by the computer:
a relevancy score relating to the relevancy of the second user's messages during the virtual conversation;
a user toxicity score relating to the toxicity level of the second user's messages during the virtual conversation; and
a user conversation score relating to the overall level of contribution of the second user to the virtual conversation.

16. The method of claim 15, wherein the conversation report further comprises the relevancy score, the user toxicity score, and the user conversation score.

17. The method of claim 1, further comprising:
receiving, from the user, a request to join the first virtual conversation room;
approving, by the computer, the request from the user;
displaying, by the computer, the first conversation room to the user;
receiving, from the user, a request to join the second virtual conversation room;
approving, by the computer, the request to join the second virtual conversation room; and
displaying, by the computer, the second virtual conversation room to the user.

18. A system for facilitating online discourse comprising one or more computers and one or more storage devices storing instructions that when executed by the one or more computers cause the one or more computers to perform operations comprising:
receiving class information associated with a class, from a user,
wherein the class information comprises a class name and a class description;
storing the class information;
receiving assignment information associated with an assignment from the user,
wherein the assignment information comprises a requirement to participate in a virtual conversation relating to a topic;
storing the assignment;
receiving, from the user:
a request to create a first virtual conversation room and a second virtual conversation room,
wherein the first virtual conversation room and the second virtual conversation room are associated with the virtual conversation;
a request to place a second user in the first virtual conversation room;
a request to place a third user in the first virtual conversation room;
a request to place a fourth user in the second virtual conversation room; and
a request to place a fifth user in the second virtual conversation room;
displaying the class, to the second user;
receiving a request from the second user to join the first virtual conversation room;
approving the request from the second user; and
displaying the first virtual conversation room to the second user.
